(19) United States
(12) Patent Application Publication
(10) Pub. No.: US 2025/0111006 A1
(43) Pub. Date: Apr. 3, 2025

(54) Fast Fourier Transforms for Processing-in-Memory

(71) Applicant: Advanced Micro Devices, Inc., Santa Clara, CA (US)

(72) Inventors: Mohamed Assem Abd ElMohsen Ibrahim, Santa Clara, CA (US); Shaizeen Dilawarhusen Aga, Santa Clara, CA (US)

(73) Assignee: Advanced Micro Devices, Inc., Santa Clara, CA (US)

(21) Appl. No.: 18/374,871

(22) Filed: Sep. 29, 2023

(51) Int. Cl. G06F 17/14; G06F 7/48; G06F 13/16

(52) U.S. Cl. CPC G06F 17/142; G06F 7/4806; G06F 13/1647

(57) ABSTRACT

Fast Fourier transforms for processing-in-memory are described. In accordance with the described techniques, a computing device includes a memory, a host processing unit, and a processing-in-memory unit that operates on data of one or more banks of the memory. The host processing unit stores interacting elements of a fast Fourier transform at locations in the one or more banks. The locations are mapped to a lane of the processing-in-memory unit. The host processing unit issues processing-in-memory commands instructing the processing-in-memory unit to load the interacting elements from the locations into the lane of the processing-in-memory unit, and execute an operation on the interacting elements.

### BACKGROUND

Processing-in-memory (PIM) architectures move processing of memory-intensive computations to memory. This contrasts with standard computer architectures which communicate data back and forth between a memory and a remote processing unit. In terms of data communication pathways, remote processing units of conventional computer architectures are further away from memory than PIM components. As a result, these conventional computer architectures suffer from increased data transfer latency, which can decrease overall computer performance. Further, due to the proximity to memory, PIM architectures can also provision higher memory bandwidth and reduced memory access energy relative to conventional computer architectures particularly when the volume of data transferred between the memory and the remote processing unit is large. Thus, PIM architectures enable increased computer performance while reducing data transfer latency as compared to conventional computer architectures that implement remote processing hardware.

### BRIEF DESCRIPTION OF THE DRAWINGS

FIG. 1 is a block diagram of a non-limiting example system having a host processing unit with a core coupled to a memory module having a memory and a processing-in-memory (PIM) unit.

FIG. 2 depicts a non-limiting example of mapping interacting elements of independent fast Fourier transforms (FFTs) to banks of the memory that the PIM unit operates on.

FIG. 3 depicts a non-limiting example of decomposing a fast Fourier transform (FFT) into a first batch of FFTs to be processed by the host processing unit, and a second batch of FFTs to be processed by the PIM unit.

FIG. 4 depicts a non-limiting example comparing operation of a baseline PIM unit to operation of an augmented PIM unit that is augmented from the baseline to include an additional add unit.

FIG. 5 depicts a procedure in an example implementation of fast Fourier transforms for processing-in-memory.

FIG. 6 depicts a procedure in an example implementation of fast Fourier transforms for processing-in-memory.

### DETAILED DESCRIPTION

### Overview

A memory architecture includes a host processing unit that is communicatively coupled via a connection (e.g., a wired and/or wireless connection) to a memory module that includes a memory and multiple processing-in-memory (PIM) units. In one or more implementations, the PIM units are single instruction, multiple data (SIMD) in-memory processors configured to process a single instruction on multiple data elements in parallel. Further, each PIM unit operates on data stored in a different set of one or more banks in the memory. In accordance with the described techniques, the PIM units are employed to execute one or more fast Fourier transforms (FFTs) to reduce traffic on the connection between the memory and the memory module.

Broadly, a FFT is an algorithm for performing a discrete Fourier transform on a sequence of complex numbers. To execute a FFT, a plurality of butterfly computations are performed on complex numbers of the FFT. In an example, a butterfly computation takes, as input, two input complex numbers, and outputs two output complex numbers. A complex number, for instance, is a number of the form a+jb in which a is the real element of the complex number and b is the imaginary element of the complex number. The real elements and the imaginary elements of the complex numbers in the sequence are “interacting elements.” This is because, in order to execute a FFT, various operations (e.g., add operations, subtract operations, and/or multiply operations) are performed in which the real elements of different complex numbers in the FFT interact, imaginary elements of different complex numbers in the FFT interact, and real elements and imaginary elements of the complex numbers in the FFT interact.

Conventional techniques for executing FFTs using PIM, however, store the interacting elements of a FFT in a same memory word, and as such, the interacting elements map to different lanes of the SIMD PIM unit. Since cross-lane communication is often unavailable for PIM-based memory architectures due to cost and/or hardware complexity concerns, a conventionally-configured host issues PIM-shift commands to align the interacting elements in a PIM unit's register file. These PIM-shift commands introduce significant traffic on the connection between the host processing unit and the memory module, thereby reducing, if not eliminating the memory bandwidth savings enabled by processing the FFT using PIM.

Further, conventional mapping techniques often map the interacting elements of a FFT to different banks that are operated on by different PIM units. Since inter-bank communication is often unavailable for PIM-based memory architectures due to cost and/or hardware complexity concerns, a conventionally-configured host copies data from one bank to another bank in order to localize the interacting elements to a set of banks operated on by a PIM unit. This involves communicating from the memory module to the host processing unit, and from the host processing unit back to the memory module via the connection, which introduces even more traffic on the connection, and further consumes memory bandwidth.

To solve these problems, the host processing unit offloads a batch of independent FFTs to multiple PIM units for processing. As part of this, the host processing unit issues mapping instructions which localize the complex numbers of respective independent FFTs in the batch to respective sets of banks operated on by respective PIM units. Given a FFT, for example, the mapping instructions store the real and imaginary elements of each complex number of the FFT in a set of one or more banks operated on by a PIM unit. In addition, the mapping instructions store the interacting elements of respective independent FFTs at locations in the memory that map to corresponding lanes of the multiple PIM units. By way of example, the interacting elements of a FFT are aligned in lane-sized portions of the one or more banks operated on by a PIM unit, and the lane-sized portions of memory are mapped to a particular lane of the PIM unit.

Once mapped, the host processing unit issues PIM commands instructing the PIM units to execute the batch of independent FFTs. By localizing the interacting elements of a respective FFT to be local to a set of banks operated on by a PIM unit, the described mapping techniques eliminate the host-initiated cross-bank communication relied on by conventional techniques. Moreover, the interacting elements of respective independent FFTs are lane-aligned in the memory via the mapping instructions, and as such, the interacting elements are similarly lane-aligned when initially loaded into the register files of the PIM units. Therefore, the described techniques eliminate use of PIM-shift commands to align the interacting elements. Accordingly, the described techniques significantly reduce the traffic on the connection between the host processing unit and the memory module, which improves memory bandwidth and overall computer performance.

In some aspects, the techniques described herein relate to a computing device, comprising a memory, a processing-in-memory unit that operates on data of one or more banks of the memory, and a host processing unit to store interacting elements of a fast Fourier transform at locations in the one or more banks, the locations being mapped to a lane of the processing-in-memory unit, and issue processing-in-memory commands instructing the processing-in-memory unit to load the interacting elements from the locations into the lane of the processing-in-memory unit, and execute an operation on the interacting elements.

In some aspects, the techniques described herein relate to a computing device, wherein the processing-in-memory unit operates on data stored in a first bank and a second bank of the memory, and the interacting elements are stored in the first bank or the second bank.

In some aspects, the techniques described herein relate to a computing device, wherein the interacting elements include a real element of a complex number and an imaginary element of the complex number, and the real element and the imaginary element are stored at corresponding locations in the first bank and the second bank, respectively.

In some aspects, the techniques described herein relate to a computing device, wherein the interacting elements include real elements of multiple complex numbers, and the real elements are stored at the locations of the first bank that map to the lane of the processing-in-memory unit.

In some aspects, the techniques described herein relate to a computing device, wherein the interacting elements include imaginary elements of multiple complex numbers, and the imaginary elements are stored at the locations of the second bank that map to the lane of the processing-in-memory unit.

In some aspects, the techniques described herein relate to a computing device, wherein the host processing unit is further configured to store additional interacting elements of an additional fast Fourier transform at additional locations in the one or more banks, the additional locations being mapped to a different lane of the processing-in-memory unit.

In some aspects, the techniques described herein relate to a computing device, wherein the processing-in-memory commands instruct the processing-in-memory unit to load the additional interacting elements from the additional locations into the different lane of the processing-in-memory unit, and execute the operation on the additional interacting elements, the operation executed on the interacting elements and the additional interacting elements in parallel.

In some aspects, the techniques described herein relate to a computing device, wherein the host processing unit is further configured to decompose the fast Fourier transform into a first batch of independent fast Fourier transforms and a second batch of independent fast Fourier transforms, execute the first batch of independent fast Fourier transforms, and offload execution of the second batch of independent fast Fourier transforms to the processing-in-memory unit via the processing-in-memory commands.

In some aspects, the techniques described herein relate to a computing device, wherein the processing-in-memory unit includes a multiply unit and one add unit configured to receive an output of the multiply unit, and to compute a butterfly for the fast Fourier transform, the host processing unit is further configured to issue a baseline number of processing-in-memory commands to the processing-in-memory unit based on the processing-in-memory unit including the multiply unit and the one add unit.

In some aspects, the techniques described herein relate to a computing device, wherein the processing-in-memory unit includes the multiply unit and two add units configured to receive the output of the multiply unit, and to compute the butterfly for the fast Fourier transform, the host processing unit is further configured to issue a reduced number of processing-in-memory commands to the processing-in-memory unit based on the processing-in-memory unit including the multiply unit and the two add units.

In some aspects, the techniques described herein relate to a computing device, wherein to compute the butterfly, the host processing unit is further configured to issue a reduced number of processing-in-memory commands based on a computation of the butterfly utilizing a particular twiddle factor.

In some aspects, the techniques described herein relate to an apparatus, comprising a memory, multiple processing-in-memory units, and a host processing unit, to receive a fast Fourier transform, decompose the fast Fourier transform into a first batch of independent fast Fourier transforms and a second batch of independent fast Fourier transforms, execute the first batch of independent fast Fourier transforms, and offload execution of the second batch of independent fast Fourier transforms to the multiple processing-in-memory units.

In some aspects, the techniques described herein relate to an apparatus, wherein the host processing unit includes a local memory, and to decompose the fast Fourier transform, the host processing unit is further configured to select a size for fast Fourier transforms in the first batch such that the fast Fourier transforms individually fit within the local memory.

In some aspects, the techniques described herein relate to an apparatus, wherein the host processing unit is further configured to execute one kernel to process the first batch of independent fast Fourier transforms based on the fast Fourier transforms in the first batch individually fitting within the local memory.

In some aspects, the techniques described herein relate to an apparatus, wherein the multiple processing-in-memory units include a first processing-in-memory unit that operates on data stored in a first set of one or more banks and a second processing-in-memory unit that operates on data stored in a second set of one or more banks.

In some aspects, the techniques described herein relate to an apparatus, wherein the host processing unit is further configured to store interacting elements of an independent fast Fourier transform of the second batch at locations in the first set of one or more banks, the locations being mapped to a lane of the first processing-in-memory unit.

In some aspects, the techniques described herein relate to an apparatus, wherein the host processing unit is further configured to store additional interacting elements of a different independent fast Fourier transform of the second batch at additional locations in the second set of one or more banks, the additional locations being mapped to an additional lane of the second processing-in-memory unit.

In some aspects, the techniques described herein relate to an apparatus, wherein to offload the execution of the second batch of independent fast Fourier transforms, the host processing unit issues processing-in-memory commands instructing the first processing-in-memory unit to load the interacting elements from the locations into the lane of the first processing-in-memory unit, and execute an operation on the interacting elements.

In some aspects, the techniques described herein relate to an apparatus, the processing-in-memory commands further instructing the second processing-in-memory unit to load the additional interacting elements from the additional locations into the additional lane of the second processing-in-memory unit, and execute the operation on the additional interacting elements, the operation executed in parallel on the interacting elements and the additional interacting elements by the lane of the first processing-in-memory unit and the additional lane of the second processing-in-memory unit, respectively.

In some aspects, the techniques described herein relate to a method, comprising receiving, by a processing-in-memory unit, processing-in-memory commands for executing multiple independent fast Fourier transforms, and responsive to receiving the processing-in-memory commands, loading, by the processing-in-memory unit, interacting elements of respective independent fast Fourier transforms directly from a memory to locations in a register file that map to respective lanes of the processing-in-memory unit, loading, by the processing-in-memory unit, the interacting elements of the respective independent fast Fourier transforms into the respective lanes of the processing-in-memory unit, and executing, by the processing-in-memory unit, an operation in parallel on the interacting elements of the respective independent fast Fourier transforms.

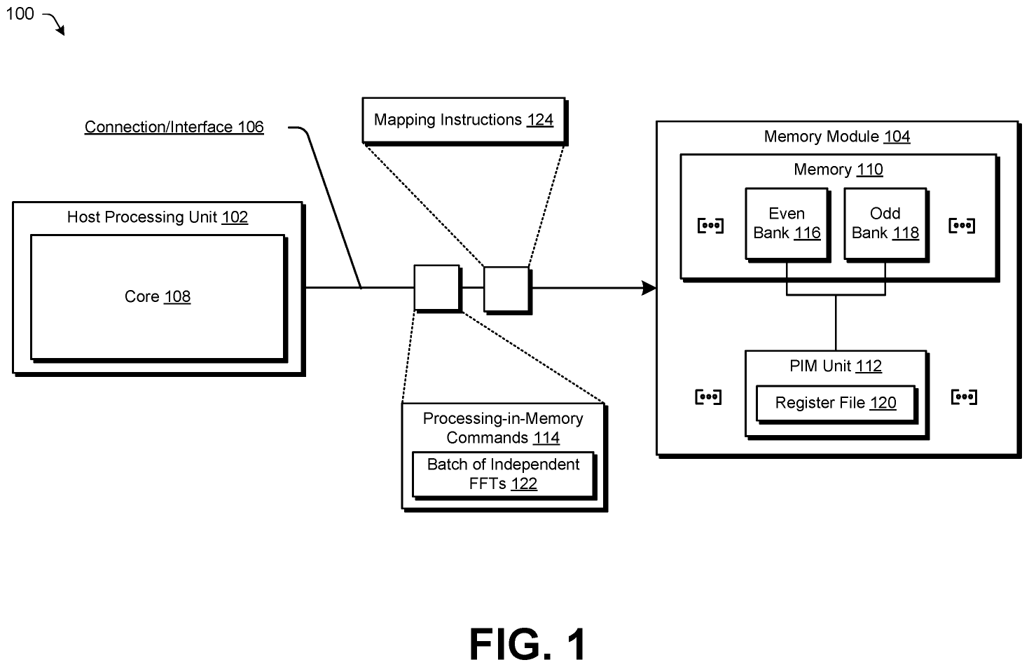

FIG. 1 is a block diagram of a non-limiting example system 100 having a host processing unit with a core coupled to a memory module having a memory and a processing-in-memory (PIM) unit. In particular, the system 100 includes a host processing unit 102 and a memory module 104, which are connected via connection/interface 106. Further, the host processing unit 102 includes a core 108, and the memory module 104 includes a memory 110 and a PIM unit 112.

In accordance with the described techniques, the host processing unit 102 and the memory module 104 are coupled to one another via a wired or wireless connection, which is illustrated as the connection/interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The host processing unit 102 is an electronic circuit that performs various operations on and/or using data in the memory 110. Examples of the host processing unit 102 and/or the core 108 include, but are not limited to, a central processing unit (CPU), a graphics processing unit (GPU), a field programmable gate array (FPGA), an accelerated processing unit (APU), and a digital signal processor (DSP). For example, the core 108 is a processing unit that reads and executes commands (e.g., of a program), examples of which include to add data, to move data, and to branch. Although one core 108 is depicted in the example system 100, the host processing unit 102 includes more than one core 108 in variations, e.g., the host processing unit 102 is a multi-core processor.

In one or more implementations, the memory module 104 is a circuit board (e.g., a printed circuit board), on which the memory 110 is mounted and includes the PIM unit 112. In some variations, one or more integrated circuits of the memory 110 are mounted on the circuit board of the memory module 104, and the memory module 104 includes one or more PIM units 112. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 and one or more PIM units 112 on a single chip. In some examples, the memory module 104 is composed of multiple chips that implement the memory 110 and the one or more PIM units 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device, e.g., by the core 108 of the host processing unit 102 and/or by the PIM unit 112. In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM). Alternatively or in addition, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). Thus, the memory 110 is configurable in a variety of ways that support fast Fourier transforms for processing-in-memory without departing from the spirit or scope of the described techniques.

Broadly, the PIM unit 112 corresponds to or includes one or more in-memory processors, e.g., embedded within the memory module 104. The in-memory processors are implemented with example processing capabilities ranging from relatively simple (e.g., an adding machine) to relatively complex (e.g., a CPU/GPU compute core). The host processing unit 102 is configured to offload memory bound computations to the one or more in-memory processors of the PIM unit 112. To do so, the core 108 generates PIM commands 114 and transmits the PIM commands 114 to the memory module 104. The PIM unit 112 receives the PIM commands 114 and processes the PIM commands 114 using the one or more in-memory processors and utilizing data stored in the memory 110.

Processing-in-memory using in-memory processors contrasts with standard computer architectures which obtain data from memory 110, communicate the data to the core 108 of the host processing unit 102, and process the data using the core 108 rather than the PIM unit 112. In various scenarios, the data produced by the core 108 as a result of processing the obtained data is written back to the memory 110, which involves communicating the produced data over the connection/interface 106 to the memory 110. In terms of data communication pathways, the core 108 is further away from the memory 110 than the PIM unit 112. As a result, these standard computer architectures suffer from increased data transfer latency, reduced data communication bandwidth, and increased data communication energy, particularly when the volume of data transferred between the memory 110 and the host processing unit 102 is large, which can also decrease overall computer performance. Thus, the PIM unit 112 enables increased computer performance while reducing data transfer energy and increasing memory bandwidth as compared to standard computer architectures which use the core 108 of the host processing unit 102 to process data. Further, the PIM unit 112 alleviates memory performance and energy bottlenecks by moving one or more memory-intensive computations closer to the memory 110.

Although one PIM unit 112 is included in the system 100 for illustrative purposes, it is to be appreciated that the memory module 104 includes a plurality of PIM units 112, in variations. As shown, the PIM unit 112 is communicatively coupled to an even bank 116 and an odd bank 118 via wired and/or wireless connections, e.g., buses (e.g., a data bus), interconnects, traces, and planes. That is, the PIM unit 112 is configured to process PIM commands 114 by operating on data stored in the even bank 116 and the odd bank 118. In multiple PIM unit scenarios, therefore, each respective PIM unit 112 operates on data stored in a respective even bank 116 of the memory 110 and a respective odd bank 118 of the memory 110. Although the PIM unit 112 is depicted and described herein as operating on data maintained in two banks, it is to be appreciated that alternative configurations are implementable in variations. Examples of alternative configurations include, but are not limited to, the PIM unit 112 operating on data of a single bank of the memory 110, the PIM unit 112 operating on three or more banks of the memory 110, the PIM unit 112 operating on data of banks of the memory 110 associated with a particular memory channel, and the PIM unit 112 operating on data of banks associated with a memory rank, and so on.

Moreover, while the PIM unit 112 is illustrated as being disposed within the memory module 104, it is to be appreciated that in some examples, the described benefits of fast Fourier transforms for processing-in-memory are realizable through near-memory processing implementations in which the PIM unit 112 is disposed in closer proximity to the memory 110 (e.g., in terms of data communication pathways and/or topology) than the core 108 of the host processing unit 102.

The PIM unit 112 is further illustrated as including a register file 120, which stores data that is accessible by the PIM unit 112, e.g., to execute one or more PIM commands 114. Data is communicated between the PIM unit 112 and the banks 116, 118 of the memory 110 in memory words, which are consistently-sized portions of data. For this reason, the register file 120 includes a plurality of registers each having a width that matches the size of the memory word. In one or more implementations, the PIM unit 112 is a single instruction, multiple data (SIMD) in-memory processor. Given this, the PIM unit 112 includes a plurality of lanes, each having a width that is a fraction (e.g., 1/16) of the width of the memory word. In accordance with SIMD processing, each lane is configured to perform a single operation on different portions of a memory word in parallel.

In an example, memory words are 256 bits, the lanes of the PIM unit are sixteen bits wide, and the host processing unit 102 issues a PIM command 114 including an add operation. In this example, a first lane of the PIM unit 112 adds a number identified by the first sixteen bits of a first register to a number identified by the first sixteen bits of a second register, a second lane of the PIM unit 112 adds a number identified by the second sixteen bits of the first register to a number identified by the second sixteen bits of the second register, and so on. Further, the duplicated add operations are performed by the different lanes of the PIM unit 112 in parallel.

In addition, PIM commands 114 are often broadcast to multiple PIM units 112 in parallel. Continuing with the above example, the host processing unit 102 issues the PIM command 114 including the add operation to multiple PIM units 112. In this example, each respective PIM unit 112 performs the add operation multiple times on different data included in the register file 120 of the respective PIM unit 112. In other words, by processing data using PIM, a first layer of parallel processing is enabled in which different data is processed by multiple PIM units 112 concurrently. Further, by processing the data using SIMD, a second layer of parallel processing is enabled in which different data is processed by multiple lanes of a respective PIM unit 112 concurrently.

In accordance with the described techniques, the host processing unit 102 executes one or more fast Fourier transforms (FFTs) and/or offloads execution of one or more FFTs to the PIM units 112. Broadly, a FFT is an algorithm that computes the discrete Fourier transform of a sequence of numbers, and oftentimes, the numbers of a FFT include complex numbers. Notably, a complex number includes a real element and an imaginary element. Imaginary elements of complex numbers are denoted herein by the letter “j.”

A FFT is computed in a number of steps, and at each step, a series of butterfly computations are performed on the complex numbers of a sequence. For example, a butterfly computation takes, as input, a first input complex number (x₁) of a sequence, and a second input complex number (x₂) of the sequence. Further, the butterfly computation outputs a first output complex number (y₁) and a second output complex number (y₂). Broadly, the first and second output complex numbers are representable as:

$${y}_{1} = {x}_{1} + ω \times {x}_{2} \qquad ( 1 )$$

$${y}_{2} = {x}_{1} - ω \times {x}_{2} \qquad ( 2 )$$

In the equations (1) and (2) above, ω is another complex number known as a twiddle factor. Although radix-2 FFTs are depicted and described herein (e.g., two complex numbers processed per butterfly computation), it is to be appreciated that the described techniques for fast Fourier transforms for processing-in-memory are extendable to other radixes, e.g., radix-3 FFTs, radix-4 FFTs, and so on.

During a first step of computing a FFT on a sequence of numbers, the butterfly computations are performed on complex numbers in the sequence that are a stride of one away from one another, and the stride doubles at each subsequent step. Thus, during the first step, a first butterfly computation is performed in which x₁ is a first complex number in the sequence and x₂ is a second complex number in the sequence. Further, during a second time step, a second butterfly computation is performed in which x₁ is a third complex number in the sequence and x₂ is a fourth complex number in the sequence, and so on. Accordingly, the output at the first step is a new sequence of complex numbers that includes the output complex numbers (e.g., y₁ and y₂) of the respective butterfly computations performed during the first step.

During a second step, the butterfly computations are performed with respect to the new sequence of complex numbers using a stride of two. For example, a first butterfly computation is performed in which x₁ is a first complex number in the new sequence and x₂ is a third complex number in the new sequence. Further, a second butterfly computation is performed in which x₁ is a second complex number in the new sequence and x₂ is a fourth complex number in the new sequence, and so on. Accordingly, for radix-2 FFTs, to compute a FFT having (n) of complex numbers in the input sequence, the above-described process is repeated over (log (n)) steps in which (n/2) butterfly computations are performed per step.

In a respective butterfly computation, the input complex numbers, and the twiddle factor are representable as:

$${x}_{1} = a + jb \qquad ( 3 )$$

$${x}_{2} = d + j e \qquad ( 4 )$$

$$ω = c + j s \qquad ( 5 )$$

Further, a delta value is computed for the respective butterfly computation, and the delta value is representable as:

$$δ = s / c \qquad ( 6 )$$

In one or more implementations, the PIM unit 112 includes a multiply unit and an add unit. Therefore, to carry out the respective butterfly computation using the PIM unit 112, the host processing unit 102 issues six PIM multiply-add (MADD) commands 114. A MADD command, for example, multiplies two values, and adds or subtracts a third value to or from the multiplication output. Accordingly, the six PIM-MADD commands 114 are representable as:

$${m}_{1} = d - δ \times e \qquad ( 7 )$$

$${m}_{2} = e + δ \times d \qquad ( 8 )$$

$$Re ( {y}_{1} ) = a + c \times {m}_{1} \qquad ( 9 )$$

$$Re ( {y}_{2} ) = a - c \times {m}_{1} \qquad ( 10 )$$

$$Im ( {y}_{1} ) = b + c \times {m}_{2} \qquad ( 11 )$$

$$Im ( {y}_{2} ) = b - c \times {m}_{2} \qquad ( 12 )$$

In the equations (7)-(12) above, Re (y₁) is the real element of the first output complex number, Re (y₂) is the real element of the second output complex number, Im (y₁) is the imaginary element of the first output complex number, and Im (y₂) is the imaginary element of the second output complex number.

As shown in equations (7) and (8), a respective butterfly computation involves PIM-MADD commands 114 that use both the real and complex elements of the second input complex number (d and e). Moreover, as shown in equations (9) and (10), a respective butterfly computation involves PIM-MADD commands 114 that use the real element of the first input complex number (a) and (m₁), which is calculated using both the real and imaginary elements of the second input complex number (d and e). Similarly, as shown in equations (11) and (12), a respective butterfly computation involves PIM-MADD commands 114 that use the imaginary element of the first input complex number (b) and (m₂), which is calculated using both the real and imaginary elements of the second input complex number (d and e). In other words, the real and imaginary elements of a given complex number in a FFT are interacting elements of a respective butterfly computation, and the real and imaginary elements of different complex numbers are interacting elements of a respective butterfly computation.

Conventional techniques for executing FFTs using PIM fail to map the complex numbers of the FFTs to the memory 110 in a way that exploits the memory bandwidth savings enabled by PIM. Given a FFT having a sequence of complex numbers, a conventional mapping spreads the sequence of complex numbers sequentially in a row across multiple banks. By way of example, a memory row of a conventional mapping includes, in sequential sixteen-bit blocks, a real element of a first complex number in the sequence, an imaginary element of a first complex number in the sequence, a real element of a second complex number in the sequence, an imaginary element of a second complex number in the sequence, and so on. Thus, for FFTs having sufficiently numerous complex numbers, the complex numbers are spread across a plurality of banks.

In small stride butterfly computations, therefore, various interacting elements of a conventionally-mapped FFT belong to a same memory word. In other words, the various interacting elements of the FFT are mapped to locations in the memory 110 such that the interacting elements, when loaded into the register file 120, are mapped to different lanes of the PIM unit 112. In various implementations, the PIM unit 112 does not include functionality to enable cross-lane communication, i.e., data processed by one lane of the PIM unit 112 is not communicable to a different lane of the PIM unit 112. Cross-lane communication is often unavailable for PIM-based architectures due to the hardware complexity and resulting cost to enable such functionality.

Therefore, in order to process a respective butterfly computation, conventional techniques utilize PIM-shift commands. Broadly, a PIM-shift command copies a memory word from a register in the register file 120 to another register in the register file 120, and shifts the copied memory word to align the interacting elements. In order to align the interacting elements, multiple PIM-shift commands are issued for each butterfly computation. Further, (n/2) butterfly computations are performed per step over (log (n)) steps for a given FFT. Accordingly, a large number of PIM-shift commands are issued to align the interacting elements of a given FFT, causing significant traffic to and from the memory module 104 on the connection/interface 106. These PIM-shift commands reduce, if not eliminate, memory bandwidth savings enabled by PIM, particularly for FFTs having more numerous complex numbers.

Further, in large stride butterfly computation, the interacting elements of a conventionally-mapped FFT are often stored at different banks of the memory 110. Given a sufficiently large stride butterfly computation, for example, the first input complex number (x₁) is mapped to a bank operated on by the PIM unit 112, and the second input complex number (x₂) is mapped to a bank operated on by a different PIM unit 112. In other words, the interacting elements of large stride butterfly computations are not local to the one or more banks (e.g., the even bank 116 and the odd bank 118) operated on by the PIM unit 112.

In various implementations, the system 100 does not include functionality (e.g., an inter-bank communication substrate) to enable inter-bank communication, i.e., data that is present in a bank operated on by the PIM unit 112 is not directly communicable to a bank that is operated on by a different PIM unit 112. Inter-bank communication is often unavailable due to the hardware complexity and cost of integrating an inter-bank communication substrate. In contrast, the host processing unit 102 of a conventionally-configured system copies data from one bank to another bank to localize the input complex numbers, (x₁) and (x₂), to the set of banks that the PIM unit 112 operates on. This involves communicating data from the memory module 104 to the host processing unit 102 via the connection/interface 106, and then back to the memory module 104 via the connection/interface 106. These communications are repeated (n/2) times per butterfly computation step having a sufficiently large stride. As such, these communications cause significant traffic on the connection/interface 106, which further consumes memory bandwidth.

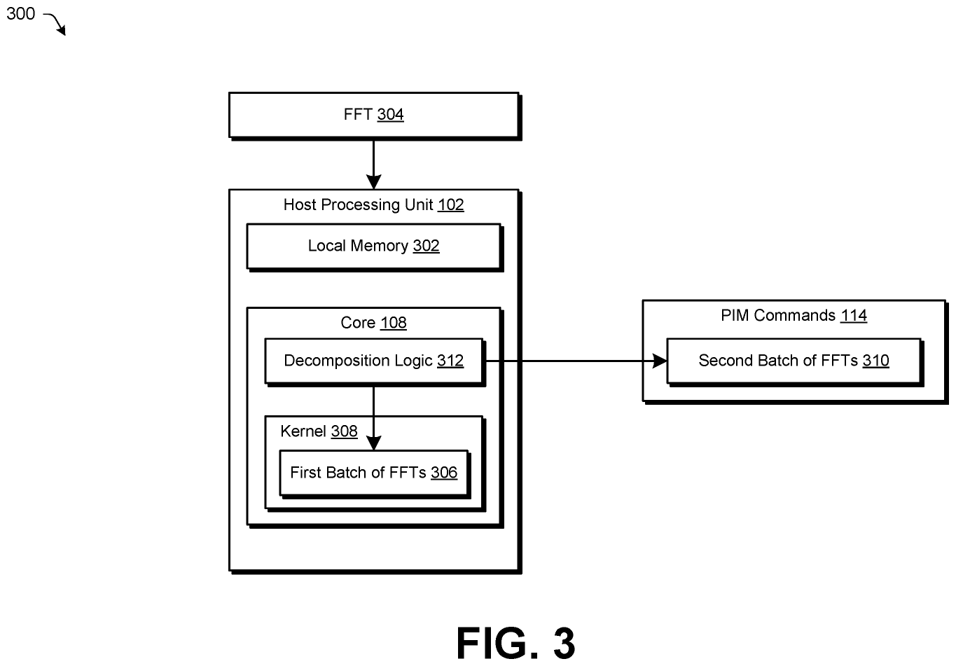

To overcome the drawbacks of conventional techniques, techniques for fast Fourier transforms for processing-in-memory are described herein. In accordance with the described techniques, the host processing unit 102 offloads execution of a batch of independent FFTs 122 for execution by the PIM unit 112. For example, the host processing unit 102 issues a series of PIM commands 114 instructing the PIM unit 112 to perform butterfly computations with respect to the batch of independent FFTs 122. In one or more implementations, the batch of independent FFTs 122 are generated by decomposing a larger FFT into a first batch of independent FFTs that are to be processed by the host processing unit 102, and a second batch of independent FFTs 122 that are to be processed by the PIM unit 112, as further discussed below with reference to FIG. 3. Additionally or alternatively, one or more FFTs in the batch of independent FFTs 122 are received by the host processing unit 102 and processed by the PIM unit 112 without the one or more FFTs being decomposed into smaller FFTs.

Prior to issuing the PIM commands 114, however, the host processing unit 102 issues a series of mapping instructions 124. Broadly, the mapping instructions 124 store complex numbers of FFTs in the batch of independent FFTs 122 at locations in the memory 110. In accordance with the described techniques, the mapping instructions 124 localize the complex numbers of each respective independent FFT to a set of banks operated on by a respective PIM unit 112. Given a respective FFT, for example, the mapping instructions 124 store each complex number of the respective FFT in the even bank 116 or the odd bank 118.

Moreover, the mapping instructions 124 store interacting elements of respective independent FFTs at locations in the even bank 116 and/or the odd bank 118 that are mapped to corresponding lanes of the PIM unit 112. For example, the interacting elements of a first independent FFT are stored at locations in the even bank 116 and/or the odd bank 118, such that the interacting elements, when loaded into the register file 120, are mapped to a first lane of the PIM unit 112. Further, the interacting elements of a second independent FFT are stored at locations in the even bank 116 and/or the odd bank 118, such that the interacting elements, when loaded into the register file 120, are mapped to a second lane of the PIM unit 112, and so on. Although examples are described herein in which the interacting elements of respective independent FFTs are loaded into corresponding lanes of the PIM unit 112 via the register file 120, it is to be appreciated that the interacting elements of the respective independent FFTs are directly loadable into the corresponding lanes of the PIM unit 112 (e.g., bypassing the register file 120), in variations.

Once mapped, the host processing unit 102 issues the PIM commands 114 instructing the PIM unit 112 to execute the batch of independent FFTs 122. By mapping the interacting elements of respective independent FFTs in this way, the described techniques reduce memory bandwidth consumption, in comparison to conventional techniques. Indeed, the described techniques do not rely on PIM-shift commands to align the interacting elements. Moreover, the described techniques do not rely on communication back and forth between the host processing unit 102 and the memory module 104 to localize interacting elements of a FFT to the one or more banks operated on by the PIM unit 112. By eliminating PIM-shift commands and host-initiated cross-bank communication, the described techniques significantly reduce traffic on the connection/interface 106, thereby exploiting the memory bandwidth savings enabled by PIM.

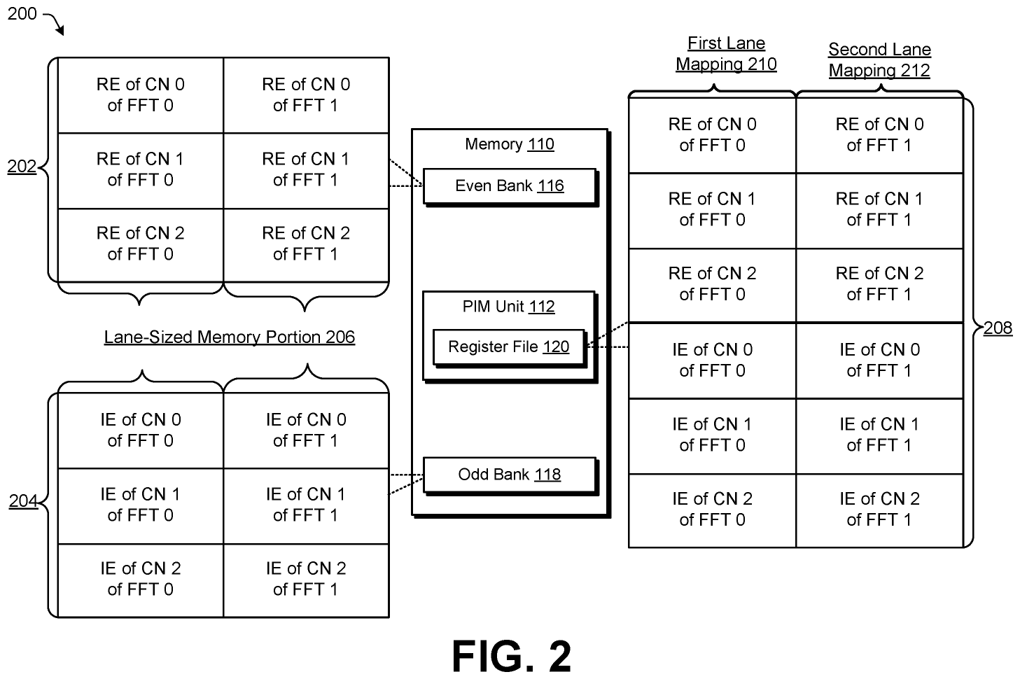

FIG. 2 depicts a non-limiting example 200 of mapping interacting elements of independent FFTs to banks of the memory that the PIM unit operates on. As shown, the example 200 includes the memory 110, including the PIM unit 112 having the register file 120, as well as the even bank 116 and the odd bank 118 operated on by the PIM unit 112. In the example 200, the mapping instructions 124 have been issued by the host processing unit 102 storing data of the batch of independent FFTs 122 in the even bank 116 and the odd bank 118 in accordance with the described techniques.

In particular, the even bank 116 includes a plurality of rows 202, and the odd bank 118 includes a plurality of rows 204. Further, the rows 202, 204 are divided into lane-sized memory portions 206. In an example in which the lanes of the PIM unit 112 are sixteen bits wide, for instance, the lane-sized memory portions 206 are contiguous sixteen-bit portions of the rows 202, 204. In this example, a first lane-sized memory portion 206 includes the first sixteen bits of the rows 202 in the even bank 116, and the first sixteen bits of the rows 204 in the odd bank 118. Further, a second lane-sized memory portion 206 includes the second sixteen bits of the rows 202 in the even bank 116, and the second sixteen bits of the rows 204 in the odd bank 118, and so on.

Moreover, the register file 120 includes a plurality of registers 208, and the registers 208 are divided into lane mappings, each of which including a lane-sized portion of data and mapping to a corresponding lane of the PIM unit 112. Continuing with the previous example in which the lanes of the PIM unit 112 are sixteen bits wide, a first lane mapping 210 of the register file 120 includes the first sixteen bits of the registers 208, a second lane mapping 212 includes the second sixteen bits of the registers 208, and so on. In this way, when data is loaded into the lanes of the PIM unit 112 for processing, data elements in the first lane mapping 210 are loaded into a first lane of the PIM unit 112, data elements in the second lane mapping 212 are loaded into a second lane of the PIM unit 112, and so on. In the depicted example 200 and the following discussion, “RE” is short for real element, “IE” is short for imaginary element, “CN” is short for complex number, and “FFT” is short for fast Fourier transform.

In the illustrated example 200, the real and imaginary elements of respective complex numbers are stored at corresponding locations in the even bank 116 and the odd bank 118, respectively. Indeed, a first complex number (e.g., CN₀) of a first FFT (e.g., FFT₀) includes a real element stored in a first lane-sized memory portion 206 in a first row 202 of the even bank 116, and an imaginary element stored in the first lane-sized memory portion 206 in a first row 204 of the odd bank 118. Further, a first complex number (e.g., CN₀) of a second FFT (e.g., FFT₁) includes a real element stored in a second lane-sized memory portion 206 in a first row 202 of the even bank 116, and an imaginary element stored in the second lane-sized memory portion 206 in a first row 204 of the odd bank 118.

In this way, when the complex numbers of the FFTs are loaded into the register file 120, the real and imaginary elements of respective complex numbers are mapped to a same lane of the PIM unit 112. As shown, for instance, the real and imaginary elements of the first complex number (e.g., CN₀) of the first FFT (e.g., FFT₀) are loaded into different registers of the first lane mapping 210. Moreover, the real and imaginary elements of the first complex number (e.g., CN₀) of the second FFT (e.g., FFT₁) are loaded into different registers of the second lane mapping 212. Therefore, a PIM-MADD command 114 that invokes the real and imaginary elements of a respective complex number is executable without issuing additional PIM-shift commands to align the real and imaginary elements.

Further, by mapping the real and imaginary elements to corresponding rows of the even bank 116 and odd bank 118, respectively, the described techniques enable the added benefit of parallel activation of the corresponding rows. For example, when the first row 204 of the even bank 116 is activated, the first row of the odd bank 116 is activated in parallel. Thus, the described techniques reduce overhead for activating and deactivating memory rows by mapping the real and imaginary elements to corresponding rows of the even bank 116 and the odd bank 118, respectively.

In the illustrated example 200, the real elements of complex numbers in a particular FFT are stored in different rows 202 of a respective lane-sized portion 206 in the even bank 116. As shown, for example, the real elements of the complex numbers in the first FFT (e.g., FFT₀) are stored in different rows 202 in the first lane-sized memory portion 206 of the even bank 116. Further, the real elements of the complex numbers in the second FFT (e.g., FFT₁) are stored in different rows 202 in the second lane-sized memory portion 206 of the even bank 116.

In addition, the imaginary elements of complex numbers in a particular FFT are stored in different rows 204 of a respective lane-sized portion 206 in the odd bank 118. As shown, for example, the imaginary elements of the complex numbers in the first FFT (e.g., FFT₀) are stored in different rows 204 in the first lane-sized memory portion 206 of the odd bank 118. Further, the imaginary elements of the complex numbers in the second FFT (e.g., FFT₁) are stored in different rows 204 in the second lane-sized memory portion 206 of the odd bank 118.

Although the mapping of example 200 is depicted and described as storing interacting elements at different rows of a particular lane-sized memory portion 206 of the banks 116, 118, it is to be appreciated that, in various scenarios, the interacting elements are stored in multiple lane-sized memory portions 206 of the banks 116, 118 that map to a same lane of the PIM unit 112. As previously discussed, the width of a memory word corresponds to the collective width of the lanes of the PIM unit 112, e.g., a memory word is 256 bits and the PIM unit 112 has sixteen lanes that are each sixteen bits wide. Thus, each contiguous memory-word-sized block (e.g., each contiguous 256 bits) of the banks 116, 118 is repeatedly mapped to the various lanes of the PIM unit 112.

Thus, in an example, the real elements of the first FFT (e.g., FFT₀) are included in a first lane-sized memory portion 206 (e.g., the first sixteen bits) in a first memory-word-sized block (e.g., in the first block of 256 bits) of the even bank 116, a first lane-sized memory portion (e.g., the first sixteen bits) in a second memory-word-sized block (e.g., the second block of 256 bits) of the even bank 116, and so on. Similarly, the imaginary elements of the first FFT (e.g., FFT₀) are included in a first lane-sized memory portion 206 (e.g., the first sixteen bits) in a first memory-word-sized block (e.g., in the first block of 256 bits) of the odd bank 118, a first lane-sized memory portion (e.g., the first sixteen bits) in a second memory-word-sized block (e.g., the second block of 256 bits) of the odd bank 118, and so on. In one or more scenarios, therefore, the interacting elements of a respective FFT are stored in corresponding lane-sized memory portions 206 within different memory-word-sized blocks of the memory 110 that map to a same lane of the PIM unit 112. In such scenarios, it is possible for the interacting elements to be mapped to a same memory row.

Given the above, when the complex numbers of the FFTs are loaded into the register file 120, the real elements and imaginary elements of complex numbers in a respective FFT are mapped to a same lane of the PIM unit 112. As shown, for example, the complex numbers (e.g., both real and imaginary elements) of the first FFT (e.g., FFT₀) are included in the first lane mapping 210, while the complex numbers (e.g., both real and imaginary elements) of the second FFT (e.g., FFT₁) are included in the second lane mapping 212. Therefore, a PIM-MADD command 114 that relies on real elements and/or imaginary elements in multiple complex numbers (e.g., x₁ and x₂) is executable without issuing additional PIM-shift commands to align the real elements and/or the imaginary elements.

Although the mapping of example 200 is depicted and described in the context of the PIM unit 112 operating on two banks (e.g., the even bank 116 and the odd bank 118), it is to be appreciated that alternative mappings are contemplated in which the PIM unit 112 operates on one bank or more than two banks. In a one-bank scenario, for instance, the interacting elements of the complex numbers in a respective FFT are stored in one or more lane-sized memory portions 206 that map to a same lane in the one bank. In a scenario in which the PIM unit 112 operates on three or more banks, the interacting elements of the complex numbers in a respective FFT are stored in one or more lane-sized memory portions in the three or more banks.

Notably, the interacting elements of respective FFTs are local to the one or more banks that the PIM unit 112 operates on when the respective FFTs are initially stored in memory 110 via the mapping instructions 124. Indeed, in the illustrated example 200, the real elements and the imaginary elements of complex numbers in a respective FFT are mapped to a same lane-sized memory portion 206 in the even bank 116 and the odd bank 118, respectively. In implementations in which the interacting elements of a respective independent FFT are stored at multiple lane-sized memory portions 206 that map to a same lane, the mapping instructions 124 ensure that the multiple lane-sized memory portions 206 to which the interacting elements are mapped belong to the one or more banks operated on by the PIM unit 112. Therefore, the described techniques eliminate host-initiated cross-bank communication to localize the interacting elements of a respective FFT to the banks 116, 118 operated on by the PIM unit 112.

Moreover, by filling the lane-sized memory portions 206 with different independent FFTs, the described techniques enable efficient utilization of the SIMD lanes of the PIM unit 112, and eliminate memory waste in the register file 120. Indeed, by mapping the FFTs in the described manner, each lane of the PIM unit 112 performs useful computations on different independent FFTs in parallel. In an example, a memory word is 256 bits, and the PIM unit 112 has sixteen lanes that are each sixteen bits wide. In this example, a PIM-MADD command 114 (e.g., represented by equation (7) or equation (8)) is issued instructing the PIM unit 112 to operate on both the imaginary element and the real element of the first complex number (e.g., CN₀) in a FFT. Further, a first register 208 includes the real element of the first complex number (e.g., CN₀) of sixteen independent FFTs that are mapped to corresponding lanes of the PIM unit 112. Similarly, a second register 208 includes the imaginary element of the first complex number (e.g., CN₀) across the sixteen independent FFTs that are mapped to corresponding lanes of the PIM unit 112. Given this, each lane of the PIM unit 112 executes the PIM-MADD command 114 on a different independent FFT in parallel.

In other words, the described mapping techniques fully utilize each lane of the PIM unit 112 to execute butterfly computations on independent FFTs in parallel. Although the example 200 is discussed above with respect to a single PIM unit 112, it is to be appreciated that independent FFTs are similarly mapped to even banks 116 and odd banks 118 operated on by a plurality of PIM units 112. Given this, each PIM unit 112 is configured to execute butterfly computations on multiple independent FFTs in parallel.

Moreover, conventional techniques that utilize PIM-shift commands to align interacting elements of a FFT store shifted duplicates of a memory word in different registers of the register file 120. In contrast, the described mapping techniques pack each lane mapping 210, 212 with useful data for executing respective independent FFTs, thereby eliminating memory waste in the register file 120.

FIG. 3 depicts a non-limiting example 300 of decomposing a FFT into a first batch of FFTs to be processed by the host processing unit, and a second batch of FFTs to be processed by the PIM unit. The host processing unit 102 includes a local memory 302, in which a particular amount of data is storable and accessible with reduced latency by the host processing unit 102, as compared to the memory 110. In various examples, the local memory 302 is a local scratchpad, one or more local caches, and the like.

As shown, the host processing unit 102 receives a FFT 304. In a standard host-based technique for executing a FFT, the host processing unit 102 analyzes the size (e.g., the number of complex numbers) of the FFT 304 to determine whether all complex numbers of the FFT 304 fit within the local memory 302. If so, the host processing unit 102 launches a single kernel to process the FFT 304 using the local memory 302. However, if the FFT 304 does not fit within the local memory 302, the host processing unit 102 decomposes the FFT 304 into two or more batches of FFTs. Consider an example in which the host processing unit 102 decomposes the FFT 304 into a first batch and a second batch, and individual FFTs in the second batch are too large to fit in the local memory 302. In this example, the host processing unit 102 further decomposes the second batch into multiple batches of FFTs. Moreover, the host processing unit 102 launches a kernel for each batch of the multiple batches of FFTs, and each kernel processes a respective one of the batches.

In accordance with the described techniques, however, the host processing unit 102 is configured to decompose the FFT 304 into two or more batches of FFTs, and offload at least one of the batches to be processed by the PIM units 112. In the illustrated example 300, for instance, the host processing unit 102 decomposes the FFT 304 into a first batch of FFTs 306 to be processed by a single kernel 308 of the host processing unit 102, and a second batch of FFTs 310 to be processed by the PIM units 112. To perform the decomposition, the host processing unit 102 employs decomposition logic 312, e.g., running on the core 108 of the host processing unit 102.

In the following discussion, consider an example in which the FFT 304 has a size of n complex numbers. In this example, the decomposition logic 312 decomposes the FFT 304 into the first batch of FFTs 306, in which there are m₂ independent FFTs each having a size of m₁ complex numbers. Further, the decomposition logic 312 decomposes the FFT 304 into the second batch of FFTs 310, in which there are m₁ independent FFTs each having a size of m₂ complex numbers. Therefore, the host processing unit 102 is configured to process m₂ independent FFTs of size m₁, while the PIM units 112 are configured to process m₁ independent FFTs of size m₂.

In examples in which there is insufficient storage in the local memory 302 to store all complex numbers of the FFT 304, the decomposition logic 312 is configured to select the size (m₁) of the independent FFTs in the first batch to be processed by the host processing unit 102, such that the number of complex numbers indicated by the size (m₁) fits within the local memory 302. For example, if the local memory 302 stores 64 kB of data, the decomposition logic 312 sets m₁ such that m₁ complex numbers are storable in less than or equal to 64 KB of memory.

In this way, fewer kernels are launched for execution on the host processing unit 102 in order to process the FFT 304, as compared to the standard host-based techniques. In an example, the FFT 304 of size n is sufficiently large to invoke the host processing unit 102 to decompose the FFT 304 into three batches of FFTs, in accordance with standard host-based techniques. Given this, a conventionally-configured host launches three kernels to process the three batches of FFTs. However, since the FFTs in the first batch of FFTs 306 fit within the local memory 302 of the host processing unit 102, the host processing unit 102 solely launches a single kernel 308 to execute the first batch of FFTs 306. Meanwhile, the host processing unit 102 offloads the remaining FFTs (e.g., the second batch of FFTs 310) to be processed by the PIM units 112. Thus, in this example, the number of kernels that are to be executed on the host processing unit 102 to process the FFT 304 is reduced from three to one, as compared to standard host-based techniques. Fewer kernels being processed by the host processing unit 102 leads to improved computational efficiency for the host processing unit 102, as a result of reduced kernel launch overhead.

It should be noted that, in various implementations, the host processing unit 102 decomposes the FFT 304 in the described manner even when there is sufficient storage in the local memory 302 to store all complex numbers of the FFT 304. Given this, a conventionally-configured host launches one kernel to process the FFT 304. Similarly, in the example 300, the host processing unit 102 launches a single kernel 308 to execute the first batch of FFTs 306. Thus, in these implementations, an equal number of kernels are executed on the host processing unit 102, as compared to conventional host-based techniques.

After the FFT is decomposed, the host processing unit 102 launches a single kernel 308 (e.g., running on the core 108 of the host processing unit 102) to execute the first batch of FFTs 306. For sufficiently large FFTs 304, the decomposition logic 312 decomposes the FFT 304 into more than two batches, and the host processing unit 102 launches more than one kernel (e.g., running on the core 108 of the host processing unit 102) to process more than one batch of FFTs. Moreover, the host processing unit 102 issues the mapping instructions 124 which map each independent FFT in the second batch of FFTs 310 to be entirely local to a respective set of banks operated on by one of the PIM units 112, as further discussed above with reference to FIG. 2. Further, the mapping instructions 124 store the interacting elements of respective independent FFTs in the second batch of FFTs 310 to locations in the memory 110 that are mapped to corresponding lanes of the respective PIM units 112, as further discussed above with reference to FIG. 2. After doing so, the host processing unit 102 issues a series of PIM commands 114 instructing the PIM units 112 to execute the second batch of FFTs 310.

One challenge for processing FFTs using PIM is that the number of PIM commands 114 that are to be processed by the PIM units 112 often create a bottleneck for the system 100. Indeed, as previously discussed, a single butterfly computation involves six PIM-MADD commands 114, each step involves (n/2) butterfly computations, and each FFT involves (log (n)) steps, in which n is the number of complex numbers of a FFT. Since the number of butterfly computations increases at the rate of n×log (n), bottlenecks are further exacerbated for FFTs having more numerous complex numbers. By decomposing the FFT 304 in the manner described, the host processing unit 102 issues fewer PIM commands 114. This reduction is achieved because the individual FFTs in the second batch of FFTs 310 are smaller than the originally-received FFT 304. In addition, by executing the first batch of FFTs 306 on the host processing unit 102, PIM commands 114 are not issued to execute the first batch of FFTs 306, thereby further reducing the number of PIM commands 114 issued. Accordingly, the described techniques alleviate bottleneck challenges that would otherwise be encountered by a system that offloads a FFT in an undecomposed state to the PIM units 112.

Moreover, the described techniques process many independent FFTs in parallel to exploit the inherent parallelism enabled by PIM and SIMD, as further discussed above with reference to FIG. 2. Indeed, the one or more banks operated on by a respective PIM unit 112 store a plurality of independent FFTs, and the memory module 104 includes a plurality of PIM units 112, in one or more implementations. Thus, in order to fill the banks operated on by the plurality of PIM units 112, a sufficient number of independent FFTs are to be offloaded for execution by the PIM units 112. By decomposing the FFT 304 in the manner described, the techniques discussed herein generate a plurality of independent FFTs to be processed by the PIM units 112 from a single received FFT 304. Further, FFTs are often processed in groups, and the host processing unit 102 receives the FFT 304 as part of a group of FFTs 304 to be processed. Given this, the host processing unit 102 decomposes each FFT 304 in the group in the manner described above, thereby creating even more independent FFTs to fill the banks operated on by the multiple PIM units 112.

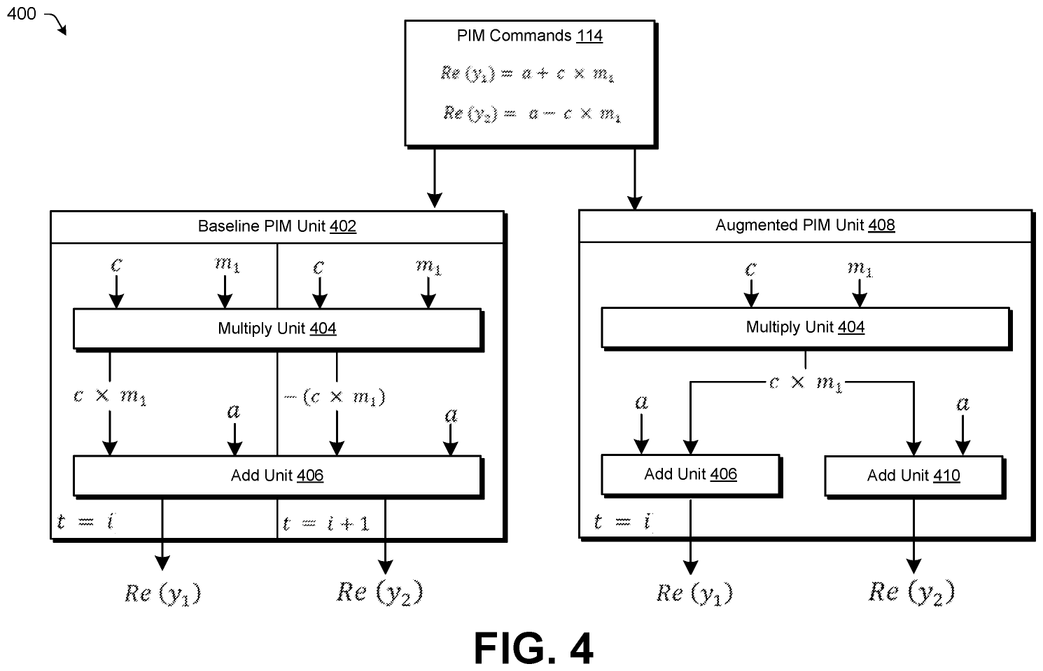

FIG. 4 depicts a non-limiting example 400 comparing operation of a baseline PIM unit to operation of an augmented PIM unit that is augmented from the baseline to include an additional add unit. The example 400 includes a baseline PIM unit 402 that includes a multiply unit 404 and an add unit 406 implemented to receive an output of the multiply unit 404, i.e., the baseline PIM unit 402 is a MADD unit. In addition, the example 400 includes an augmented PIM unit 408 including the multiply unit 404, and two add units 406, 410 implemented to receive an output of the multiply unit 404, i.e., the augmented PIM unit 408 is a MADD unit augmented to include an additional add unit 410. The example 400 illustrates how the augmented PIM unit 408 is leveraged to execute a butterfly computation in a reduced number of PIM commands 114, as compared to the baseline PIM unit 402. In particular, the example 400 illustrates how the baseline PIM unit 402 and the augmented PIM unit 408 carry out a computation of the real elements of the output complex numbers, e.g., Re(y₁) and Re(y₂).

For ease of reference, equations (3) and (4) defining the input complex numbers (x₁ and x₂), equation (5) defining the twiddle factor (ω), equation (6) defining the delta value (δ), and equations (7)-(12) defining the six PIM-MADD commands 114 issued by the host processing unit 102 to the baseline PIM unit 402 to carry out a respective butterfly computation are reproduced below:

$${x}_{1} = a + jb \qquad ( 3 )$$

$${x}_{2} = d + je \qquad ( 4 )$$

$$ω = c + js \qquad ( 5 )$$

$$δ = s / c \qquad ( 6 )$$

$${m}_{1} = d - δ \times e \qquad ( 7 )$$

$${m}_{2} = e + δ \times d \qquad ( 8 )$$

$$Re ( {y}_{1} ) = a + c \times {m}_{1} \qquad ( 9 )$$

$$Re ( {y}_{2} ) = a - c \times {m}_{1} \qquad ( 10 )$$

$$Im ( {y}_{1} ) = b + c \times {m}_{2} \qquad ( 11 )$$

$$Im ( {y}_{2} ) = b - c \times {m}_{2} \qquad ( 12 )$$

Given that the baseline PIM unit 402 includes solely one add unit 406 implemented downstream from the multiply unit 404, one multiply operation followed by one accumulate operation (e.g., add operation or subtract operation) on the output of the multiply unit 406 is performable in a given time step. Therefore, in a first time step (e.g., t=i), the baseline PIM unit 402 multiplies c×m₁ using the multiply unit 404, and adds the output of the multiply unit 404 to a using the add unit 406. In a second time step (e.g., t=i+1), the baseline PIM unit 402 multiplies c×m₁ using the multiply unit 404, and subtracts the output of the multiply unit 404 from a using the add unit 406. The host processing unit 102 thus issues two PIM-MADD commands 114 (e.g., representable as equations (9) and (10)) to compute the real elements of the first and second output complex numbers.

Although not depicted, the host processing unit 102 similarly issues two PIM-MADD commands 114 (e.g., representable as equations (11) and (12)) to the baseline PIM unit 402 to compute the imaginary elements of the first and second output complex numbers (e.g., Im (y₁) and Im (y₂)). To carry out equation (11), the baseline PIM unit 402 multiplies c×m₂ using the multiply unit 404, and adds the output of the multiply unit 404 to b using the add unit 406 in a first time step. To carry out equation (12), the baseline PIM unit 402 multiplies c×m₂ using the multiply unit 404, and subtracts the output of the multiply unit 404 from b using the add unit 406 in a second time step.

Since the augmented PIM unit 408 includes two add units 406, 410 implemented downstream from the multiply unit 404, one multiply operation followed by two accumulate operations (e.g., add operations or subtract operations) on the output of the multiply unit are performable in a given time step. Therefore, in a first time step (e.g., t=i), the augmented PIM unit 408 multiplies c×m₁ using the multiply unit 404, adds the output of the multiply unit 404 to a using the add unit 406, and subtracts the output of the multiply unit 404 from a using the add unit 410. The host processing unit 102 thus issues one PIM-MADD command 114 to compute the real elements of the first and second output complex numbers.

Although not depicted, the host processing unit 102 similarly issues one PIM-MADD command 114 to compute the imaginary elements of the first and second output complex numbers (e.g., Im (y₁) and Im (y₂)). By way of example, in a single time step, the augmented PIM unit 408 multiplies c×m₂ using the multiply unit 404, adds the output of the multiply unit 404 to b using the add unit 406, and subtracts the output of the multiply unit 404 from b using the add unit 410. Accordingly, by augmenting the PIM unit to include an add unit 410, the host processing unit 102 issues four PIM-MADD commands 114 to carry out a butterfly computation rather than six.

In one or more implementations, the host processing unit 102 is employed to issue even fewer PIM-MADD commands 114 by exploiting butterfly computations that utilize specific twiddle factors. One example twiddle factor is ω=1. For butterfly computations using this twiddle factor, the input and output complex numbers are representable by the following equations:

$$Re ( {y}_{1} ) = a + d \qquad ( 13 )$$

$$Re ( {y}_{2} ) = a - d \qquad ( 14 )$$

$$Im ( {y}_{1} ) = b + e \qquad ( 15 )$$

$$Im ( {y}_{2} ) = b - e \qquad ( 16 )$$

Accordingly, in implementations in which the baseline PIM unit 402 is leveraged, the host processing unit 102 issues four PIM-MADD commands 114 (e.g., represented as equations (13)-(16)) to carry out a butterfly computation having a twiddle factor of ω=1. However, since the augmented PIM unit 408 is configured to add and subtract in a single time step, the host processing unit 102 combines equations (13) and (14) into a single PIM-MADD command 114, and combines equation (15) and (16) into a single PIM-MADD command 114. Thus, in implementations in which the augmented PIM unit 408 is leveraged, the host processing unit 102 issues two PIM-MADD commands 114 to carry out a butterfly computation having a twiddle factor of ω=1.

Another example twiddle factor is ω=−j. For butterfly computations using this twiddle factor, the input and output complex numbers are representable by the following equations:

$$Re ( {y}_{1} ) = a - e \qquad ( 17 )$$

$$Re ( {y}_{2} ) = a + e \qquad ( 18 )$$

$$Im ( {y}_{1} ) = b - d \qquad ( 19 )$$

$$Im ( {y}_{2} ) = b + d \qquad ( 20 )$$

Accordingly, in implementations in which the baseline PIM unit 402 is leveraged, the host processing unit 102 issues four PIM-MADD commands 114 (e.g., represented as equations (17)-(20)) to carry out a butterfly computation having a twiddle factor of ω=−j. However, since the augmented PIM unit 408 is configured to add and subtract in a single time step, the host processing unit 102 combines equations (17) and (18) into a single PIM-MADD command 114, and combines equations (19) and (20) into a single PIM-MADD command 114. Thus, in implementations in which the augmented PIM unit 408 is leveraged, the host processing unit 102 issues two PIM-MADD commands 114 to carry out a butterfly computation having a twiddle factor of ω=−j.

Another example twiddle factor is ω=±1\sqrt{2}±(1\sqrt{2})j. For butterfly computations having this twiddle factor, the delta value is δ=±1 due to the symmetry between the real and imaginary elements of the twiddle factor. Therefore, m₁ and m₂ are representable by the following equations:

$${m}_{1} = \pm d \pm e \qquad ( 21 )$$

$${m}_{2} = \pm e \pm d \qquad ( 22 )$$

Since the augmented PIM unit 408 is configured to add and subtract in a single time step, the host processing unit 102 combines equations (21) and (22) into a single PIM-MADD command 114. Thus, in implementations in which the augmented PIM unit 408 is leveraged, the host processing unit 102 issues three PIM-MADD commands 114 to carry out a butterfly computation having a twiddle factor of ω=±1\sqrt{2}±(1\sqrt{2})j. For example, one PIM-MADD command 114 is issued to compute m₁ and m₂, one PIM-MADD command 114 is issued to compute Re (y₁) and Re (y₂), and one PIM-MADD command 114 is issued to compute Im (y₁) and Im (y₂)).

In sum, by implementing the augmented PIM unit 408, the number of PIM-MADD commands 114 issued per butterfly computation is reduced from six to four regardless of the twiddle factor. Further, the host processing unit 102 is configured to issue three PIM-MADD commands 114 to the augmented PIM unit 408 to carry out a butterfly computation having a twiddle factor of ω=±1\sqrt{2}±(1\sqrt{2})j. Moreover, the host processing unit 102 is configured to issue two PIM-MADD commands 114 to the augmented PIM unit 408 to carry out a butterfly computation having a twiddle factor of ω=1 or ω=−j. By issuing fewer PIM commands 114 per butterfly computation, the PIM commands 114 are less likely to create a bottleneck in the system 100.

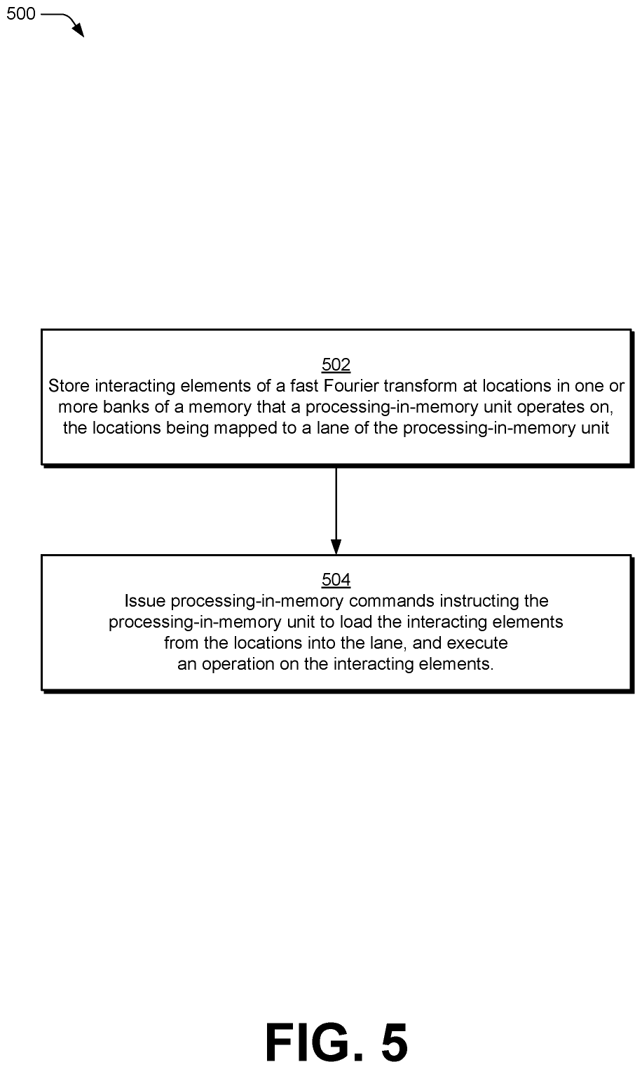

FIG. 5 depicts a procedure 500 in an example implementation of fast Fourier transforms for processing-in-memory.

Interacting elements of a fast Fourier transform are stored at locations in one or more banks of a memory that a processing-in-memory unit operates on, and the locations are mapped to a lane of the processing-in-memory unit (block 502). For example, the host processing unit 102 issues mapping instructions 124 which store the real elements of complex numbers in a FFT in one or more lane-sized memory portions 206 of the even bank 116 which are mapped to a particular lane of the PIM unit 112. The mapping instructions 124 further store the imaginary elements of complex numbers in the FFT in the one or more lane-sized memory portions 206 of the odd bank 116 which are mapped to the particular lane of the PIM unit 112. In one or more implementations, the real and imaginary elements of respective complex numbers in the FFT are stored in corresponding rows of the even bank 116 and the odd bank 118, respectively.

Processing-in-memory commands are issued instructing the processing-in-memory unit to load the interacting elements from the locations into the lane, and execute an operation on the interacting elements (block 504). By way of example, the host processing unit 102 issues PIM commands 114, which instruct the PIM unit 112 to perform operations for executing the FFT. For instance, the PIM commands 114 instruct the PIM unit 112 to load interacting elements of the FFT (e.g., real and/or imaginary elements of the FFT) from the one or more lane-sized memory portions 206 into the register file 120. In this way, the interacting elements of the FFT are aligned within a same lane mapping (e.g., the first lane mapping 210) in different registers 208 of the register file 120. The PIM commands 114 further instruct the PIM unit 112 to execute an operation on the interacting elements. To do so, the PIM unit 112 loads the interacting elements from the lane mapping into a lane of the PIM unit 112, and executes the operation using the lane.

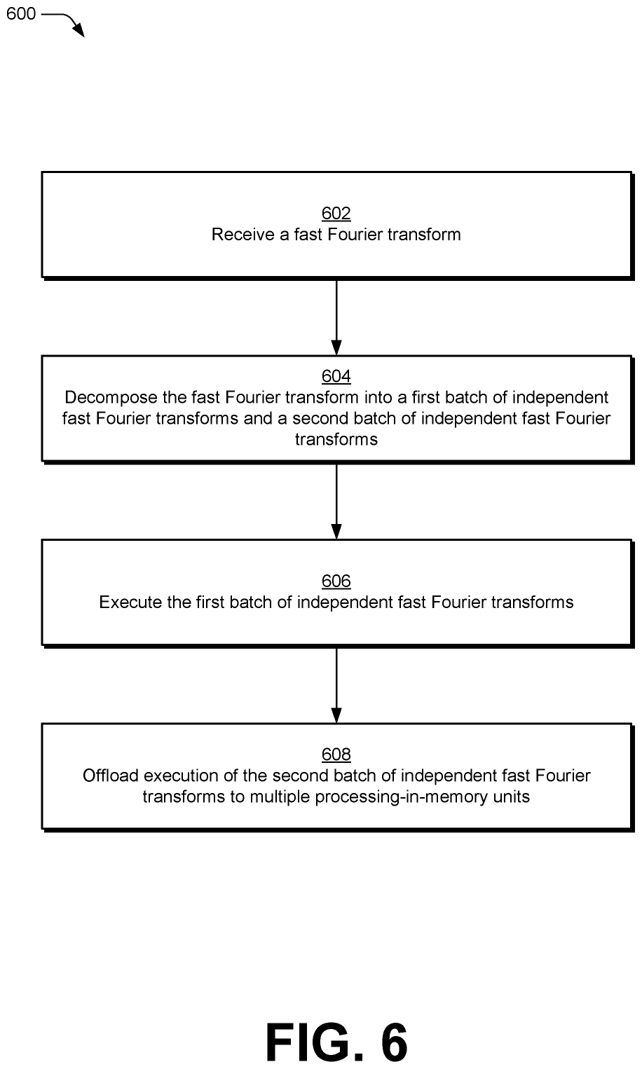

FIG. 6 depicts a procedure 600 in an example implementation of fast Fourier transforms for processing-in-memory.

A fast Fourier transform is received (block 602). For example, the host processing unit 102 receives the FFT 304 including a sequence of complex numbers. The fast Fourier transform is decomposed into a first batch of independent fast Fourier transforms and a second batch of independent fast Fourier transforms (block 604). By way of example, the decomposition logic 312 decomposes the FFT 304 into a first batch of FFTs 306, and a second batch of FFTs 310.

The first batch of independent fast Fourier transforms is executed (block 606). By way of example, a single kernel 308 is launched to execute on the host processing unit 102 in order to process the first batch of FFTs 306. In at least one example, the decomposition logic 312 specifies a number of complex numbers to be included in individual FFTs of the first batch of FFTs 306, such that the number of complex numbers fits within the local memory 302. Given this, the host processing unit 102 launches a single kernel 308 to execute the first batch of FFTs 306 using the local memory 302.

Execution of the second batch of independent fast Fourier transforms is offloaded to multiple processing-in-memory units (block 608). For example, the host processing unit 102 issues the mapping instructions 124 with respect to the second batch of FFTs 310. That is, the host processing unit 102 stores the interacting elements of respective FFTs at locations in a plurality of banks operated on by multiple PIM units 112, such that the locations map to corresponding lanes of the multiple PIM units 112. Further, the mapping instructions 124 ensure that each respective independent FFT is fully local to a respective set of banks operated on by a respective PIM unit 112. The host processing unit 102 then issues the PIM commands 114 instructing the multiple PIM units to execute independent FFTs in the second batch of FFTs 310 in parallel. For instance, the multiple PIM units 112 load interacting elements of respective FFTs into respective lanes of the multiple PIM units 112 via the register files 120. Further, the multiple PIM units 112 execute an operation on the interacting elements of the respective FFTs in parallel.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the host processing unit 102, the memory module 104, the core 108, the memory 110, the PIM unit 112, the local memory 302, the kernel 308, the baseline PIM unit 402, the multiply unit 404, the add units 406, 410, and the augmented PIM unit 408) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device, comprising:
a memory;
a processing-in-memory unit that operates on data of one or more banks of the memory; and
a host processing unit to:
store interacting elements of a fast Fourier transform at locations in the one or more banks, the locations being mapped to a lane of the processing-in-memory unit; and
issue processing-in-memory commands instructing the processing-in-memory unit to load the interacting elements from the locations into the lane of the processing-in-memory unit, and execute an operation on the interacting elements.

2. The computing device of claim 1, wherein the processing-in-memory unit operates on data stored in a first bank and a second bank of the memory, and the interacting elements are stored in the first bank or the second bank.

3. The computing device of claim 2, wherein the interacting elements include a real element of a complex number and an imaginary element of the complex number, and the real element and the imaginary element are stored at corresponding locations in the first bank and the second bank, respectively.

4. The computing device of claim 2, wherein the interacting elements include real elements of multiple complex numbers, and the real elements are stored at the locations of the first bank that map to the lane of the processing-in-memory unit.

5. The computing device of claim 2, wherein the interacting elements include imaginary elements of multiple complex numbers, and the imaginary elements are stored at the locations of the second bank that map to the lane of the processing-in-memory unit.

6. The computing device of claim 1, wherein the host processing unit is further configured to store additional interacting elements of an additional fast Fourier transform at additional locations in the one or more banks, the additional locations being mapped to a different lane of the processing-in-memory unit.

7. The computing device of claim 6, wherein the processing-in-memory commands instruct the processing-in-memory unit to load the additional interacting elements from the additional locations into the different lane of the processing-in-memory unit, and execute the operation on the additional interacting elements, the operation executed on the interacting elements and the additional interacting elements in parallel.

8. The computing device of claim 1, wherein the host processing unit is further configured to:
decompose the fast Fourier transform into a first batch of independent fast Fourier transforms and a second batch of independent fast Fourier transforms;
execute the first batch of independent fast Fourier transforms; and
offload execution of the second batch of independent fast Fourier transforms to the processing-in-memory unit via the processing-in-memory commands.

9. The computing device of claim 1, wherein the processing-in-memory unit includes a multiply unit and one add unit configured to receive an output of the multiply unit, and to compute a butterfly for the fast Fourier transform, the host processing unit is further configured to issue a baseline number of processing-in-memory commands to the processing-in-memory unit based on the processing-in-memory unit including the multiply unit and the one add unit.

10. The computing device of claim 9, wherein the processing-in-memory unit includes the multiply unit and two add units configured to receive the output of the multiply unit, and to compute the butterfly for the fast Fourier transform, the host processing unit is further configured to issue a reduced number of processing-in-memory commands to the processing-in-memory unit based on the processing-in-memory unit including the multiply unit and the two add units.

11. The computing device of claim 9, wherein to compute the butterfly, the host processing unit is further configured to issue a reduced number of processing-in-memory commands based on a computation of the butterfly utilizing a particular twiddle factor.

12. An apparatus, comprising:
a memory;
multiple processing-in-memory units; and
a host processing unit, to:
receive a fast Fourier transform;
decompose the fast Fourier transform into a first batch of independent fast Fourier transforms and a second batch of independent fast Fourier transforms;
execute the first batch of independent fast Fourier transforms; and
offload execution of the second batch of independent fast Fourier transforms to the multiple processing-in-memory units.

13. The apparatus of claim 12, wherein the host processing unit includes a local memory, and to decompose the fast Fourier transform, the host processing unit is further configured to select a size for fast Fourier transforms in the first batch such that the fast Fourier transforms individually fit within the local memory.

14. The apparatus of claim 13, wherein the host processing unit is further configured to execute one kernel to process the first batch of independent fast Fourier transforms based on the fast Fourier transforms in the first batch individually fitting within the local memory.

15. The apparatus of claim 12, wherein the multiple processing-in-memory units include a first processing-in-memory unit that operates on data stored in a first set of one or more banks and a second processing-in-memory unit that operates on data stored in a second set of one or more banks.

16. The apparatus of claim 15, wherein the host processing unit is further configured to store interacting elements of an independent fast Fourier transform of the second batch at locations in the first set of one or more banks, the locations being mapped to a lane of the first processing-in-memory unit.

17. The apparatus of claim 16, wherein the host processing unit is further configured to store additional interacting elements of a different independent fast Fourier transform of the second batch at additional locations in the second set of one or more banks, the additional locations being mapped to an additional lane of the second processing-in-memory unit.

18. The apparatus of claim 17, wherein to offload the execution of the second batch of independent fast Fourier transforms, the host processing unit issues processing-in-memory commands instructing the first processing-in-memory unit to load the interacting elements from the locations into the lane of the first processing-in-memory unit, and execute an operation on the interacting elements.

19. The apparatus of claim 18, the processing-in-memory commands further instructing the second processing-in-memory unit to load the additional interacting elements from the additional locations into the additional lane of the second processing-in-memory unit, and execute the operation on the additional interacting elements, the operation executed in parallel on the interacting elements and the additional interacting elements by the lane of the first processing-in-memory unit and the additional lane of the second processing-in-memory unit, respectively.

20. A method, comprising:
receiving, by a processing-in-memory unit, processing-in-memory commands for executing multiple independent fast Fourier transforms; and
responsive to receiving the processing-in-memory commands:
loading, by the processing-in-memory unit, interacting elements of respective independent fast Fourier transforms directly from a memory to locations in a register file that map to respective lanes of the processing-in-memory unit;
loading, by the processing-in-memory unit, the interacting elements of the respective independent fast Fourier transforms into the respective lanes of the processing-in-memory unit; and
executing, by the processing-in-memory unit, an operation in parallel on the interacting elements of the respective independent fast Fourier transforms.
